(19) United States
(12) Patent Application Publication
(10) Pub. No.: US 2003/0092406 A1
(43) Pub. Date: May 15, 2003

(54) Radio communication system, and transmitting circuit and receiving circuit thereof

(75) Inventors: Yasuhiro Ito, Tokyo (JP); Yasuaki Nishida, Tokyo (JP); Takashi Ando, Tokyo (JP); Kazuhiro Daikoku, Tokyo (JP); Shinichi Hosoya, Tokyo (JP)

Correspondence Address: John Russell Uren, P. Eng., 1337 Gulf Road, P.O. Box 1304, Point Roberts, WA, 98281-1304, US

(73) Assignee: NIPPON HOSO KYOKAI

(21) Appl. No.: 10/274,289

(22) Filed: Oct. 18, 2002

(30) Foreign Application Priority Data
Oct. 24, 2001 (JP) 2001-326553

(51) Int. Cl. H04B 1/04

(52) U.S. Cl. 455/126; 455/139

(57) ABSTRACT

This invention addresses itself to the task of securing excellent narrowband transmission quality when transmitting audio signals such as voice and music, or various kinds of multimedia signal, by means of unidirectional or broadcast communication systems. Excellent demodulation characteristics are obtained by reducing the required transmission bandwidth by using SSB modulation technology, and by performing RZ SSB demodulation at the receiving side. The sideband and the carrier component are transmitted at a sufficient distance from one another in the frequency domain so that even if frequency stability in the transmitting and receiving circuits is not very high, there is little likelihood of quality deterioration due to frequency instability, and so that the receiving circuit is easier to implement, since less sharply selective bandpass filters are required. At the receiving side, the sideband and the carrier component undergo separate frequency conversions that convert them to signals that are suitable for RZ SSB demodulation.

### BACKGROUND OF THE INVENTION

1. Field of the Invention

The present invention relates to a radio communication system which, despite being a narrowband system, is capable of securing excellent transmission quality. It also relates to a transmitting circuit and a receiving circuit thereof. The invention relates more particularly to a technique for transmitting audio signals such as voice and music, and various kinds of multimedia signal.

2. Description of Related Art

(1) Wideband Frequency Modulation and Demodulation

Radio microphone equipment is an example of transmitter and receiver circuits for radio communication of high-quality audio signals such as voice and music. Standards relating to such radio microphone equipment include RCR STD-15, “Radio-Microphone For Specified Low Power Radio Station” and RCR STD-22, “Specified Radio-Microphone For Land Mobile Radio Station”. Wideband frequency modulation and demodulation technology is adopted in these standards.

The RCR STD-15 standard provides different specifications according to the radio frequency region to be used. Namely, for the 70 MHz band, the modulating frequency and the occupied bandwidth are respectively ≦10 kHz and 60 kHz. For the 300 MHz band, they are ≦7 kHz and 30 kHz, and for the 800 MHz band, they are ≦15 kHz and 110 kHz.

According to RCR STD-22, the occupied bandwidth required for transmitting a monophonic signal with an audio bandwidth not exceeding 15 kHz is 110 kHz when the frequency deviation is within ±40 kHz (=2×(15+40) kHz), and is 330 kHz when the frequency deviation exceeds ±40 kHz but is within ±150 kHz (=2×(15+150) kHz). The figures in brackets show the application of Carson's rule. The occupied bandwidth for transmitting a stereophonic signal is 250 kHz.

(2) Digital Mobile Radio

RCR STD-39 is an example of a standard for the digital mobile radio technology used to transmit various kinds of multimedia signal. This standard prescribes for three modulation schemes, namely: M16QAM, a/4-shift QPSK and 16QAM. In each scheme the channel spacing is 25 kHz. The transmission rate and occupied bandwidth are 64 kbps and 24.3 kHz with M16QAM, 32 kbps and 24.3 kHz with a/4-shift QPSK, and 64 kbps and 20 kHz with 16QAM.

These prior arts have some problems as follows.

(1) Wideband Frequency Modulation and Demodulation

The following problems have been encountered with radio microphone equipment based on conventional wideband frequency modulation and demodulation.

1. Wideband frequency modulation and demodulation are needed for the transmission of high-quality audio signals. An inherent advantage of frequency modulation is that highly power efficient nonlinear amplifiers can be used, and hence it has been applied to radio microphone equipment and so forth. However, the wideband FM specified in the above-mentioned standards involves a considerable occupied bandwidth, ranging from 4.3 (=30/7) to 22 (=330/15) times the modulating signal bandwidth. In other words, a problem encountered with wideband frequency modulation and demodulation is poor spectrum utilization efficiency.

2. As the number of radio microphone equipment users increases, wideband frequency modulation and demodulation is becoming unable to meet increasing demand with existing limited radio spectrum resources, and hence occupied bandwidth has to be narrowed However, in the case of radio microphone equipment, because transmission quality cannot be sacrificed, it is difficult to achieve a significant narrowing of bandwidth by changing from wideband to narrowband FM, as was previously done in order to increase capacity in land radio systems for business use.

(2) Digital Mobile Radio

Some of the problems encountered in connection with the RCR STD-39 standard are as follows. Namely, the M16QAM and 16QAM modulation schemes are susceptible to the effects of fading and hence cannot always secure adequate transmission quality. In addition, these modulation schemes have small radio service areas. Problems encountered with N/4 QPSK include a low spectrum utilization efficiency of 1.28 (=32/25) bit/Hz, and a practical throughput of only around 60 to 70%.

### SUMMARY OF THE INVENTION

It is therefore an object of the present invention to provide a radio communication system having high spectrum utilization efficiency and capable of achieving significantly greater narrowing of occupied bandwidth and channel spacing than the wideband FM systems and digital mobile radio technologies in current use, while maintaining high transmission quality. It is another object of this invention to provide a transmitting circuit and a receiving circuit thereof.

According to a first aspect, the present invention provides a radio communication system comprising: transmitting means for allocating an information signal to a suppressed carrier sideband of a single-sideband signal, and for transmitting this sideband along with a pilot signal, this pilot signal being a carrier component with a different frequency from the carrier used to form the sideband; and receiving and demodulating means for receiving and demodulating the signal transmitted from the transmitting means; wherein this receiving and demodulating means comprises: means for forming a single-sideband signal, this means performing separate frequency conversions of the sideband and the pilot signal in the received signal, thereby providing a carrier component with the same frequency relation to the frequency-converted sideband as that between the carrier used to form the sideband transmitted by the transmitting means and the transmitted sideband; and means for demodulating the information signal from the phase term, i.e., from the real zeros, of the single-sideband signal thereby obtained.

Demodulating an information signal from the phase term of a single-sideband signal, i.e., from the real zeros, is known as Real Zero Single Sideband (RZ SSB) technology, and provides excellent narrowband demodulation characteristics. A detailed description of RZ SSB modulation and demodulation technology is given in JP H06-018333 B (granted as Japanese Patent No. 1888866). In order to utilize this technology to realize a narrowband radio communication system giving excellent transmission quality, the present invention adds novel ideas to the methods employed to form the modulated wave and to demodulate this wave.

The transmitting means of this invention is preferably adapted to transmit after allocating one of two independent information signals to the upper sideband and the other information signal to the lower sideband; and the receiving and demodulating means of the invention is preferably adapted to demodulate the upper sideband and the lower sideband as separate single sidebands.

When a stereophonic audio signal is to be transmitted as the information signal, a modulated wave for transmission is formed by allocating the right (R) and left (L) channel signals to, for example, the upper sideband and the lower sideband, and adding a carrier component (the pilot signal) that will be required for demodulation of the modulated wave. Alternatively, the stereophonic signal can be transmitted after allocating the difference signal (L−R) and the sum signal (R+L), these being formed by a matrix circuit, to the upper and lower sidebands respectively, or after making the reverse allocation. On the other hand, a monophonic signal (R+L) is transmitted after being allocated to one sideband, which may be either the upper sideband or the lower sideband.

When various kinds of multimedia signal are to be transmitted as the information signal, two transmission configurations are feasible. Namely, the information signal can be transmitted after being split into two independent signals which are allocated respectively to the upper and lower sidebands, or it can be transmitted via just one sideband.

If the carrier used to form the upper and lower sidebands is also used as the carrier component (pilot signal), then, because the frequency stability of the local oscillators employed in the transmitting and receiving circuits is limited, the resulting frequency fluctuation means that the bandpass filter that serves to extract the carrier component present between the upper and lower sidebands is required to have extremely sharp selectivity, which is difficult to achieve. As opposed to this, the present invention takes the frequency stability of the local oscillators into consideration and arranges the upper and lower sidebands at a sufficient distance in the frequency domain from the carrier component (the pilot signal) to enable the carrier component (the pilot signal) to be extracted by a less sharply selective bandpass filter. Because the present invention transmits the modulated signal on this basis, it has the advantage of enabling the carrier component (the pilot signal) to be extracted more easily by the receiving circuit. Given such a signal arrangement, a high-quality demodulated signal can be obtained by means of a comparatively simple circuit configuration.

Moreover, with conventional single sideband (SSB) demodulation, detuning distortion occurs due to off-set frequency, and this causes a marked deterioration in the quality of the demodulated signal. However, RZ SSB demodulation uses a technique which in principle rules out the occurrence of such distortion, and can therefore overcome this defect of conventional SSB demodulation.

According to a second aspect, the present invention provides a transmitting circuit that is used in the radio communication system described above This transmitting circuit comprises: means for modulating a first carrier with an information signal to form a single-sideband suppressed carrier signal; and means for adding a pilot signal to this single-sideband suppressed carrier signal, this pilot signal being a carrier component with a different frequency from the above-mentioned first carrier.

One of two independent information signals is preferably transmitted after being allocated to the upper sideband, and the other after being allocated to the lower sideband. The means for forming the single-sideband suppressed carrier signal can comprise: first circuit means for using one of the two independent information signals and a signal of first angular frequency ω₁ to form a suppressed carrier upper sideband signal, and second circuit means for using the other of the two independent information signals and a signal of second angular frequency ω₂ to form a suppressed carrier lower sideband signal; and the means for adding the pilot signal can comprise third circuit means for adding the suppressed carrier upper sideband signal, the suppressed carrier lower sideband signal, and a pilot signal of third angular frequency ω₃ such that ω₁>ω₃>ω₂. The third angular frequency ω₃ is preferably set so that ω₃=(ω₁+ω₂)/2.

According to a third aspect, the present invention provides a receiving circuit that is used in the radio communication system described above. Namely, the invention provides a receiving circuit for receiving, along with a carrier component, a modulated wave resulting from an information signal having been allocated to a sideband, and for demodulating this modulated wave; wherein the carrier component is a pilot signal with a different frequency from the carrier used to form the above-mentioned sideband; and this receiving circuit comprises: means for forming a single-sideband signal, this means performing separate frequency conversions of the sideband and the pilot signal in the received signal, thereby providing a carrier component with the same frequency relation to the frequency-converted sideband as that between the carrier used to form the transmitted sideband and the transmitted sideband; and means for demodulating the information signal from the phase term of the single-sideband signal thereby obtained.

The means for forming a single-sideband signal preferably comprises means for separating the upper sideband and the lower sideband and for processing these as separate single sideband modulated waves. This processing means preferably comprises means for forming, from the received signal, two independent signals occupying the same frequency range but which have mutually reversed frequency component distributions in the frequency domain.

This means for forming two independent signals can comprise: first frequency conversion means for using a first local oscillator signal to frequency convert the received signal to a first frequency band (ω₄); second frequency conversion means for using a second local oscillator signal (ω₅) of a higher frequency than the first local oscillator signal to frequency convert the output of this first frequency conversion means, and for extracting the difference frequency component (ω₅−ω₄) and the sum frequency component (ω₅+ω₄), which have mutually reversed frequency component distributions in the frequency domain; pilot signal extraction means for branching the output of the first frequency conversion means, limiting the amplitude, and extracting the pilot signal (ω₄); third frequency conversion means for using the extracted pilot signal to frequency convert the difference frequency component, and for extracting the sum frequency component (ω₅); and fourth frequency conversion means for using the extracted pilot signal to frequency convert the sum frequency component that has been extracted by the second frequency conversion means, and for extracting the difference frequency component (ω₅).

An additional advantage of this configuration is that because frequency conversion is performed using the extracted pilot signal, random FM noise is removed.

It is also feasible to provide the receiving circuit of this invention with a space diversity configuration. Namely, a plurality of receiving antennas can be provided; each of this plurality of receiving antennas can be provided with means for forming the above-mentioned two independent signals; and means can be provided for adding the corresponding independent signals that are output from each of these means for forming the two independent signals.

The above-mentioned processing means can comprise: means for using a third local oscillator signal to frequency convert each of the above-mentioned two independent signals; means for branching at least one of these two independent signals; using a fourth local oscillator signal differing from the third local oscillator signal by a prescribed frequency to frequency convert the branched signal; and extracting a carrier component with the same frequency relation to the sidebands of the two independent signals as that between the carrier used to form the sidebands transmitted by the transmitting means and the transmitted sidebands; and means for adding this extracted carrier component to the output of the means for using the third local oscillator signal to frequency convert each of the two independent signals.

The above-mentioned means for extracting the carrier component can be adapted to use the same local oscillator signal to separately extract, for each of the two independent signals, the carrier component; and the above-mentioned adding means can be adapted to add, for each of these two independent signals, the output of the frequency conversion means and the output of the extraction means.

A receiving circuit constituted as described above is not affected by the frequency stability of the transmitter and receiver oscillators, and can readily utilize RZ SSB demodulation. Hence a high-quality demodulated signal can be secured, within the frequency stability range of the upper and lower sidebands and the carrier component (pilot signal). Moreover, multiplicative noise generated in the propagation path can easily be removed, and high-fidelity information signal reproduction characteristics can be secured.

Preferably, the present invention uses digital signal processing (DSP) technology so that the high-precision signal processing required in the transmitting and receiving circuits can be performed easily. Use of this technology renders circuit adjustment unnecessary and means that DSP processors can be used, which can be expected to offer volume production benefits. As a result, the receiver will have a less expensive configuration, thereby ensuring economic manufacture.

### BRIEF DESCRIPTION OF THE DRAWINGS

Specific embodiments of the present invention will now be described, by way of example only, with reference to the accompanying of drawings in which:

FIG. 1 is a block diagram showing a transmitting circuit according to a first embodiment of the present invention;

FIG. 2 shows an exemplary arrangement in the frequency domain of the sidebands and carrier component (pilot signal) to be transmitted;

FIG. 3 is a block diagram showing a receiving circuit according to a second embodiment of the present invention;

FIG. 4 shows an exemplary arrangement in the frequency domain of sidebands and carrier components during the frequency conversions taking place in the receiving circuit of FIG. 3;

FIG. 5 is a block diagram showing an example in which a partial circuit has been added to the receiving circuit of the second embodiment; and

FIG. 6 is a block diagram of a receiving circuit according to a third embodiment of the present invention, and shows a receiving circuit that employs two-branch space diversity reception.

### DETAILED DESCRIPTION OF THE PREFERRED EMBODIMENTS

Examples of transmitting a stereophonic signal using radio microphone equipment will now be described in detail to illustrate modes of embodying the present invention. The following embodiments serve to clarify the substance of this invention. Nevertheless, the invention is not restricted to these embodiments.

First Embodiment

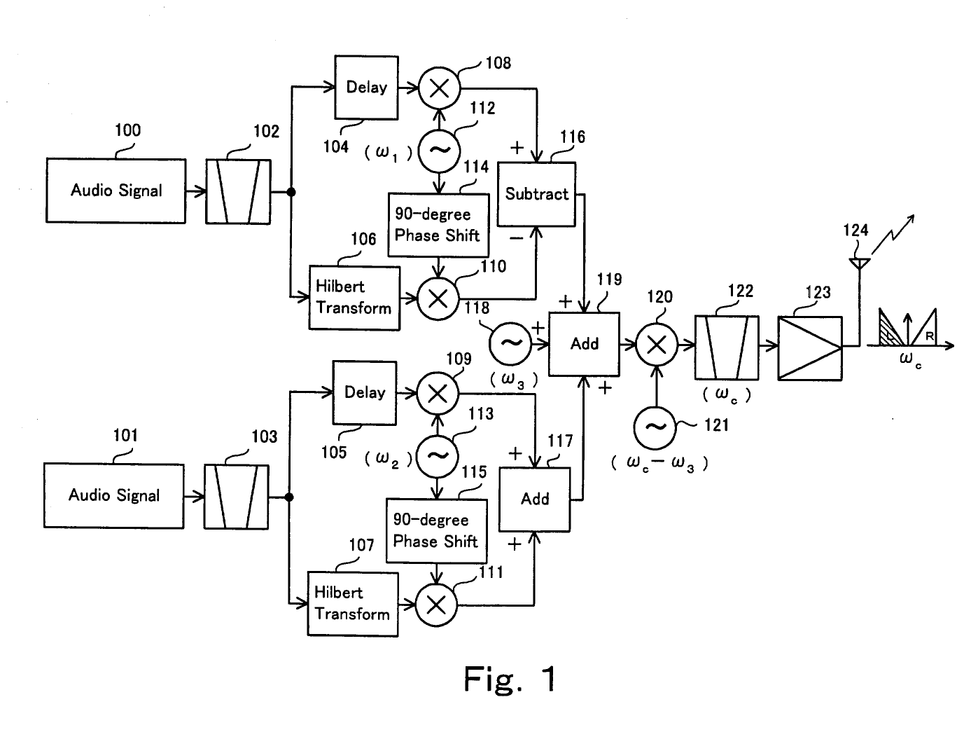

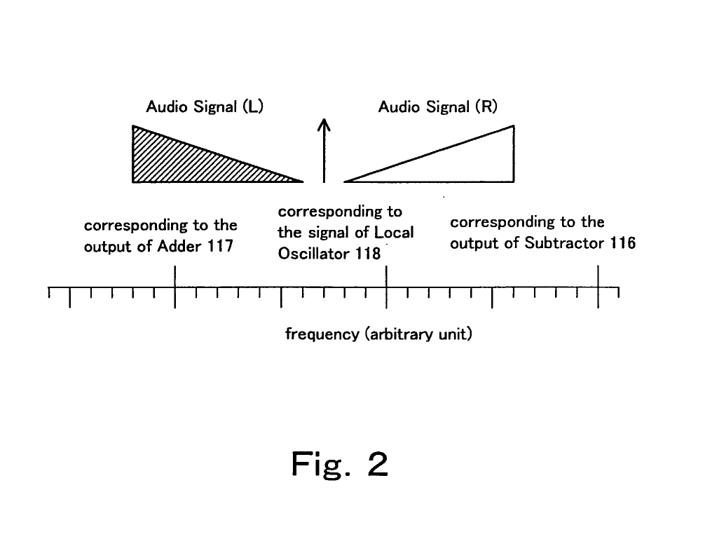

A first embodiment of the present invention will be described with reference to FIG. 1 and FIG. 2. FIG. 1 is a block diagram of this first embodiment, and shows an example of the constitution of a transmitting circuit. In this first embodiment we describe the use of a known phase-shift method for forming single-sideband (SSB) signals in the transmitting circuit, but other methods of generating SSB signals are known, such as the use of a bandpass filter, or the Weaver method. FIG. 2 shows an exemplary arrangement in the frequency domain of the sidebands and carrier component to be transmitted. In FIG. 1, 100 and 101 respectively reference right-channel (R) and left-channel (L) audio signals, which have already undergone some signal processing. The transmitting circuit shown in FIG. 1 comprises bandpass filters 102 and 103, delay circuits 104 and 105, Hilbert transformers 106 and 107, multipliers 108, 109, 110 and 111, local oscillators 112 and 113, 90-degree phase shifters 114 and 115, subtractor 116, adder 117, local oscillator 118, adder 119, frequency converter 120, local oscillator 121, intermediate frequency (IF) filter 122, transmitter 123 and transmitting antenna 124.

A brief description will now be given of signal flow in the transmitting circuit shown in FIG. 1, and of the functioning of its component circuits.

Bandpass filters 102 and 103 remove unwanted frequencies from right-channel audio signal 100 and left-channel audio signal 101 respectively. Delay circuit 104 and Hilbert transformer 106 generate mutually orthogonal signals from the output of bandpass filter 102. 90-degree phase shifter 114 ensures that the two outputs from local oscillator 112 are mutually orthogonal. These orthogonal signals are multiplied together by multipliers 108 and 110, whereby the upper sideband (USB) is formed when the outputs of these multipliers are subtracted by subtractor 116. This method of generating an SSB signal is called the phase-shift method.

The lower sideband (LSB) is likewise generated from the output of bandpass filter 103 using the phase-shift method. Namely, delay circuit 105 and Hilbert transformer 107 generate mutually orthogonal signals from the output of bandpass filter 103. 90-degree phase shifter 115 ensures that the two outputs from local oscillator 113 are mutually orthogonal. These orthogonal signals are multiplied together by multipliers 109 and 111, whereby the lower sideband (LSB) is formed when the outputs of these multipliers are added by adder 117.

The output of subtractor 116 in which the USB has been formed, the output of adder 117 in which the LSB has been formed, and the output of local oscillator 118, are added by adder 119. The output of local oscillator 118 is the signal component that is required in order to generate the carrier component that will be needed for the demodulation. The carrier component does not carry the information signal, and so to increase the transmission efficiency of the transmitted wave, the carrier component is added at as low a power as possible relative to the power of the USB and LSB signals.

The output of adder 119 is frequency converted by frequency converter 120 using the signal from local oscillator 121, and the required frequency component is extracted by IF filter 122 and amplified by transmitter 123, whereupon the resulting radio wave is radiated from transmitting antenna 124. In this example, for the sake of simplicity, the frequency converters have been assumed to consist of just one stage, but the number of stages can be increased as required.

The operation of each component circuit will now be further described using mathematical expressions. Let signal-processed right-channel (R) audio signal 100 be g_{R}(T), the output of delay circuit 104 be g_{R}(T−τ)=G_{R}(t), and the output of Hilbert transformer 106 be H(g_{R}(T−τ))=H(G_{R}(t)), where H(g(T)) represents the Hilbert transformation of g(T), τ represents the processing delay of the Hilbert transformer, and T and t are time variables. Similarly, let the output of delay circuit 105 in response to left-channel (L) audio signal 101 be G_{L}(t) and the output of Hilbert transformer 107 be H(G_{L}(t)).

Letting the angular frequency of local oscillator 112 be ω₁, the upper sideband (USB) will be formed in the output of subtractor 116. This can be described as:

Susb(t)=G_{R}(t)cos(ω₁t)−H(G_{R}(t))sin(ω₁t) (1)

Letting the angular frequency of local oscillator 113 be ω₂, the lower sideband (LSB) will be formed in the output of adder 117. This can be described as:

Slsb(t)=G_{L}(t)cos(ω₂t)+H(G_{L}(t))sin(ω₂t) (2)

Note that it is assumed that ω₁>ω₂.

Next, when the signal with angular frequency ω₃ and amplitude K from local oscillator 118 is added by adder 119 to the upper and lower sidebands described by Equations 1 and 2, the output of adder 119 becomes:

St(t)=K cos(ω₃t)+G_{R}(t)cos(ω₁t)−H(G_{R}(t))sin(ω₁t)+G_{L}(t)cos(ω₂t)+H(G_{L}(t))sin(ω₂t) (3)

On the assumption that the relation between angular frequency ω₃ of the carrier component (the pilot signal) and the other angular frequencies is given by:

ω₃=(ω₁+ω₂)/2 (4)

then in this example the carrier component (the pilot signal) will be inserted centrally between the upper sideband (USB) and the lower sideband (LSB). In addition, we will write the frequency spacing Δω between ω₁ and ω₂ as:

Δω=ω₁−ω₂ (5)

From Equations 4 and 5 we get:

Δω₁=ω₃+Δω/2

Δω₂=ω₃−Δω/2 (6)

Moreover, taking into account the information transmission efficiency of the transmitted wave, we have chosen K such that:

K<|G_{R}(t)|

K<|G_{L}(t)|

Using Equation 6, Equation 3 can be transformed into:

St(t)=K cos(ω₃t)+G_{R}(t)cos(ω₃+Δω/2)t)−H(G_{R}(t))sin(ω₃+Δω/2)t)+G_{L}(t)cos(ω₃·Δω/2)t)+H(G_{L}(t))sin(ω₃−Δω/2)t) (7)

When the signal expressed by Equation 7 is frequency converted by means of the signal from local oscillator 121, this local oscillator signal having a center angular frequency of ω_{C}−ω₃ and an angular frequency fluctuation of ±δω_{c}, it becomes:

ST(t)=K cos(ω_{C}±δω_{c}))t)+G_{R}(t)cos(ω_{C}±δω_{c}+Δω/2)t)−H(G_{R}(t))sin(ω_{C}±δω_{c}+Δω/2)t)+G_{L}(t)cos(ω_{C}±δω_{c}−Δω/2)t)+H(G_{L}(t))sin(ω_{C}+δω_{c}−Δω/2)t) (8)

The component described by Equation 8 is extracted by IF filter 122 without inclusion of unwanted components and without exclusion of the required component, and its power amplified by transmitter 123, whereupon the extracted component is radiated from transmitting antenna 124.

If circuit elements 100 to 119 in the transmitting circuit shown in FIG. 1 are constituted using a DSP processor, a high-precision transmitted signal can be formed.

A transmitting circuit used to transmit a stereophonic signal has been described with reference to FIG. 1. When this circuit is applied in a transmitter capable of monophonic transmission only, the monophonic signal (R+L) is introduced as signal-processed audio signal 101, and the unnecessary circuit elements—from audio signal 100 to subtractor 116—can be removed. Conversely, if the monophonic signal (R+L) is introduced as signal-processed audio signal 100, circuit elements from audio signal 101 to adder 117 can be removed.

Second Embodiment

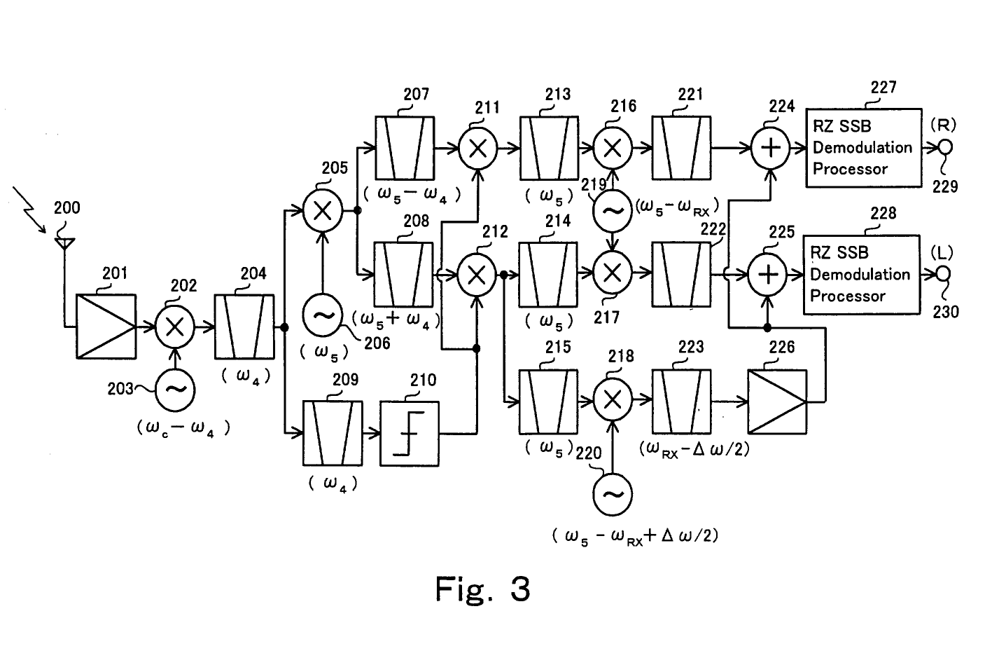

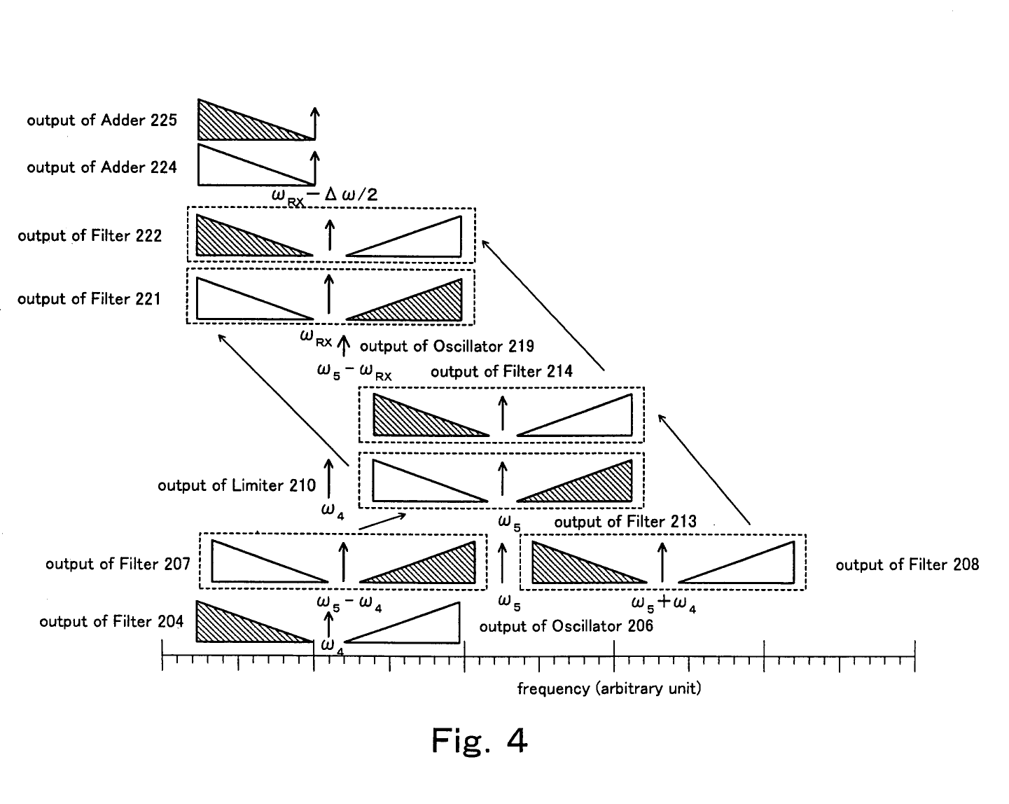

A second embodiment of the present invention will now be described with reference to FIG. 3 and FIG. 4. FIG. 3 shows the constitution of a receiving circuit for receiving the signal that has been transmitted from the transmitting circuit shown in FIG. 1. FIG. 4 shows an exemplary arrangement in the frequency domain of sidebands and carrier components during the frequency conversions taking place in this receiving circuit. The receiving circuit shown in FIG. 3 comprises receiving antenna 200, front end amplifier 201, frequency converter 202, local oscillator 203, IF filter 204, frequency converter 205, local oscillator 206, IF filters 207, 208 and 209, amplitude limiter 210, frequency converters 211 and 212, IF filters 213, 214 and 215, frequency converters 216, 217 and 218, local oscillators 219 and 220, IF filters 221, 222 and 223, amplifier 226, adders 224 and 225, RZ SSB demodulation processors 227 and 228, and demodulated signal output terminals 229 and 230.

The signal flow in the receiving circuit of this second embodiment shown in FIG. 3 and the functioning of its component circuits will now be described.

The signal received by receiving antenna 200 is amplified to the required level by front end amplifier 201. The amplified signal is frequency converted by frequency converter 202, using the output signal of local oscillator 203. IF filter 204 extracts this required frequency-converted component without inclusion of unwanted components and without exclusion of the required component.

The output signal from IF filter 204 is split into two. Using the output signal of local oscillator 206, frequency converter 205 converts one of these split signals into difference and sum frequencies, and these signal components are extracted by IF filters 207 and 208 without inclusion of unwanted components and without exclusion of the required components. IF filter 209 extracts only the carrier component (pilot signal) from the other split output signal of IF filter 204, and amplitude limiter 210 gives this extracted carrier component a constant amplitude. The outputs of IF filters 207 and 208 are respectively input to frequency converters 211 and 212, where they are frequency converted using the output of amplitude limiter 210.

The outputs of frequency converters 211 and 212 are respectively supplied to IF filters 213 and 214, which extract the required components without inclusion of unwanted components and without exclusion of the required components, which are then frequency converted by frequency converters 216 and 217 using the output signal of local oscillator 219. IF filters 221 and 222 extract only the lower sideband component from the respective output signals of frequency converters 216 and 217.

Meanwhile, IF filter 215 extracts the carrier component from the output of frequency converter 212, frequency converter 218 uses the output signal of local oscillator 220 to frequency convert this carrier component, and IF filter 223 extracts only the required component.

In this embodiment, the frequency of local oscillator 220 is set so that the frequency of the frequency-converted signal output from frequency converter 218 matches the carrier frequency component of the lower sideband signal that was previously extracted by IF filters 221 and 222. The power of the output of IF filter 223 is amplified by amplifier 226.

When the output of amplifier 226 is added by means of adders 224 and 225 to the outputs of IF filters 221 and 222 respectively, the outputs of IF filters 221 and 222 are converted to lower sideband signals to which has been added a carrier component with the same frequency relation to the frequency-converted sidebands as that between the carrier used to form the sidebands transmitted by the transmitting means and the transmitted sidebands. These lower sideband signals are supplied respectively to RZ SSB demodulation processors 227 and 228, which perform RZ SSB demodulation processing. A demodulated signal reproducing the right-channel (R) that was transmitted by the transmitter shown in FIG. 1 is obtained at demodulated signal output terminal 229, and a demodulated signal reproducing the left-channel (L) is obtained at demodulated signal output terminal 230.

The operation of each component circuit will now be described using mathematical expressions. Radio waves that have radiated from the transmitter shown in FIG. 1 and propagated through the propagation path are received by receiving antenna 200 and are then amplified to the required level by front end amplifier 201. Due to multiplicative disturbance occurring in the propagation path, this signal becomes:

SR(t)=ρ(t)[K cos(ω_{C}±δω_{c})t+θ(t))+G_{R}(t)cos(ω_{C}±δω_{c}+Δω/2)t+θ(t))−H(G_{R}(t))sin(ω_{C}±δω_{c}+Δω/2)t+θ(t))+G_{L}(t)cos(ω_{C}±δω_{c}−Δω/2)t+θ(t))+H(G_{L}(t))sin(ω_{C}±δω_{c}−Δω/2)t+θ(t))] (9)

where ±δω_{c} is the angular frequency fluctuation of the transmitter (δω_{c}<<ω_{C}) and ρ(t) and θ(t) are respectively the random amplitude fluctuation and the phase fluctuation (random FM noise), which obey the Rayleigh distribution rule and are affected by the propagation path. This description of the received signal ignores amplifier gain and thermal noise, the latter being additive noise generated in the amplifier.

When the signal described by Equation 9 is frequency converted by frequency converter 202 using the output signal from local oscillator 203, which has a center angular frequency of ω_{C}−ω₄ and an angular frequency fluctuation of ±δω (where δω<<ω_{C}−ω₄), it becomes:

SR1(t)=ρ(t)[K cos((Ω₄t+θ(t))+G_{R}(t)cos((Ω₄+Δω/2)t+θ(t))−H(G_{R}(t))sin((Ω₄+Δω/2)t+θ(t))+G_{L}(t)cos((Ω₄−ω/2)t+θ(t))+H(G_{L}(t))sin((Ω₄−Δω/2)t+θ(t)) (10)

and hence only the desired wave is extracted by IF filter 204. To simplify this equation we have used the substitution:

Ω₄=ω₄±δω_{c}±(−δω)

The IF frequency converter has been described as having just one stage, but in practice the number of stages can easily be increased as required.

When the output signal from IF filter 204, which can be described by Equation 10, is frequency converted by frequency converter 205 using the output signal from local oscillator 206, which has an angular frequency of ω₅, the difference frequency can be extracted by IF filter 207 and the sum frequency by IF filter 208. The difference frequency component can be described by the following mathematical expression:

SRsub(t)=ρ(t)[K cos((Ω₄−ω₅)t+θ(t))+G_{R}(t)cos((Ω₄−ω₅+Δω/2)t+θ(t))−H(G_{R}(t))sin((Ω₄−ω₅+Δω/2)t+θ(t))+G_{L}(t)cos((Ω₄−ω₅−Δω/2)t+θ(t))+H(G_{L}(t))sin((Ω₄−ω₅−Δω/2)t+θ(t))]=ρ(t)[K cos((ω₅−Ω₄)t−θ(t))+G_{R}(t)cos((ω₅−Ω₄−ΔΩ/2)t−θ(t))+H(G_{R}(t))sin((ω₅−Ω₄−Δω/2)t−θ(t))+G_{L}(t)cos((ω₅−Ω₄+Δω/2)t−θ(t))−H(G_{L}(t))sin((ω₅−Ω₄+Δω/2)t−θ(t))] (11)

Because it has been assumed here that ω₅>ω₄, comparison of Equation 10 and Equation 11 shows that the upper and lower sideband components in Equation 10 are transposed in Equation 11. Next, the sum frequency component can be described by the following mathematical expression:

SRsum(t)=ρ(t)[K cos((Ω₄+ω₅)t+θ(t))+G_{R}(t)cos((Ω₄+ω₅+Δω/2)t+θ(t))−H(G_{R}(t))sin((Ω₄+ω₅+Δω/2)t+θ(t))+G_{L}(t)cos((Ω₄+ω₅−Δω/2)t+θ(t))+H(G_{L}(t))sin((Ω₄+ω₅−Δω/2)t+θ(t))] (12)

and therefore in this case the upper and lower sideband components do not change.

When the carrier component alone is extracted from the output of IF filter 204 by IF filter 209 and its amplitude fixed by amplitude limiter 210, the random amplitude fluctuation component ρ(t) is removed and the signal obtained is given by:

SRlim(t)=cos(Ω₄t+θ(t)) (13)

When the output of IF filter 207, which can be described by Equation 11, and the output of amplitude limiter 210, which can be described by Equation 13, are input to frequency converter 211, and the sum frequency generating function of frequency converter 211 is used, the signal obtained is:

SFsub(t)=ρ(t)[K cos(ω₅t)+G_{R}(t)cos((ω₅−Δω/2)t)+H(G_{R}(t))sin((ω₅−Δω/2)t)+G_{L}(t)cos((ω₅+Δω/2)t)−H(G_{L}(t))sin((ω₅+Δω/2)t)] (14)

When the output of IF filter 208, which can be described by Equation 12, and the output of amplitude limiter 210, which can be described by Equation 13, are input to frequency converter 212, and the difference frequency generating function of frequency converter 212 is used, the signal obtained is:

SFsum(t)=ρ(t)[K cos(ω₅t)+G_{R}(t)cos((ω₅+Δω/2)t)−H(G_{R}(t))sin((ω₅+Δω/2)t)+G_{L}(t)cos((ω₅−Δω/2)t)+H(G_{L}(t))sin((ω₅−Δω/2)t)] (15)

It will be seen that the angular frequency of the carrier component in both Equation 14 and Equation 15 has become ω₅ and that in both equations the angular frequency fluctuation (±δω_{c}±(−δω)) and the random FM noise component θ(t) have been completely removed. Moreover, the fact that the angular frequency of the carrier component in both Equation 14 and Equation 15 is ω₅ means that after this stage in the processing, the frequency stability is determined solely by the frequency stability of local oscillator 206. RZ SSB demodulation processing can then be performed on the-basis of the signals described by Equation 14 and Equation 15, after extracting the respective signals by means of IF filters 213 and 214. However, because the frequency region in which a DSP processor can be effectively used is limited, it, was decided in the present invention that the signals described by Equation 14 and Equation 15 would be shifted to as low a frequency region as possible.

Accordingly, when the respective outputs of IF filters 213 and 214 are shifted to a low frequency region by frequency converters 216 and 217 using the output of local oscillator 219 having angular frequency ω₅−ω_{RX}, and the lower sideband component alone is extracted using IF filters 221 and 222, the output signal from IF filter 221 is given by:

SZsub(t)=ρ(t)[G_{R}(t)cos((ω_{RX}−Δω/2)t)+H(G_{R}(t))sin((ω_{RX}−Δω/2)t)] (16)

and the output signal from IF filter 222 is given by:

SZsum(t)=ρ(t)[G_{L}(t)cos((ω_{RX}−Δω/2)t)+H(G_{L}(t))sin((ω_{RX}−Δω/2)t)] (17)

Meanwhile, the carrier component is extracted by IF filter 215 from the output signal of frequency converter 212, and frequency converted by frequency converter 218 using the output of local oscillator 220 having angular frequency ω₅−ω_{RX}+Δω/2. The effective component is then extracted by IF filter 223. The resulting signal is given by:

SRZcari(t)=ρ(t)cos((ω_{RX}−Δω/2)t) (18)

After amplification by amplifier 226, this signal is added by adders 224 and 225 to the outputs of IF filters 221 and 222 respectively.

The output signal of adder 224 is:

SRZsub(t)=ρ(t)[(1+G_{R}(t))cos((ω_{RX}−Δω/2)t)+H(G_{R}(t))sin((ω_{RX}−Δω/2)t)] (19)

and the output signal of adder 225 is:

SRZsum(t)=ρ(t)[(1+G_{L}(t))cos((ω_{RX}−Δω/2)t)+H(G_{L}(t))sin((ω_{RX}−Δω/2)t)] (20)

A necessary condition for the RZ SSB demodulation processing to function is that:

|G_{R}(t)|<1

|G_{L}(t)|<1

and hence the degree of amplification provided by amplifier 226 is set so that this condition is satisfied.

When the outputs of adders 224 and 225 are input to RZ SSB demodulation processors 227 and 228 respectively, the right-channel demodulated signal is obtained at demodulation signal output terminal 229 and the left-channel demodulated signal is obtained at demodulation signal output terminal 230.

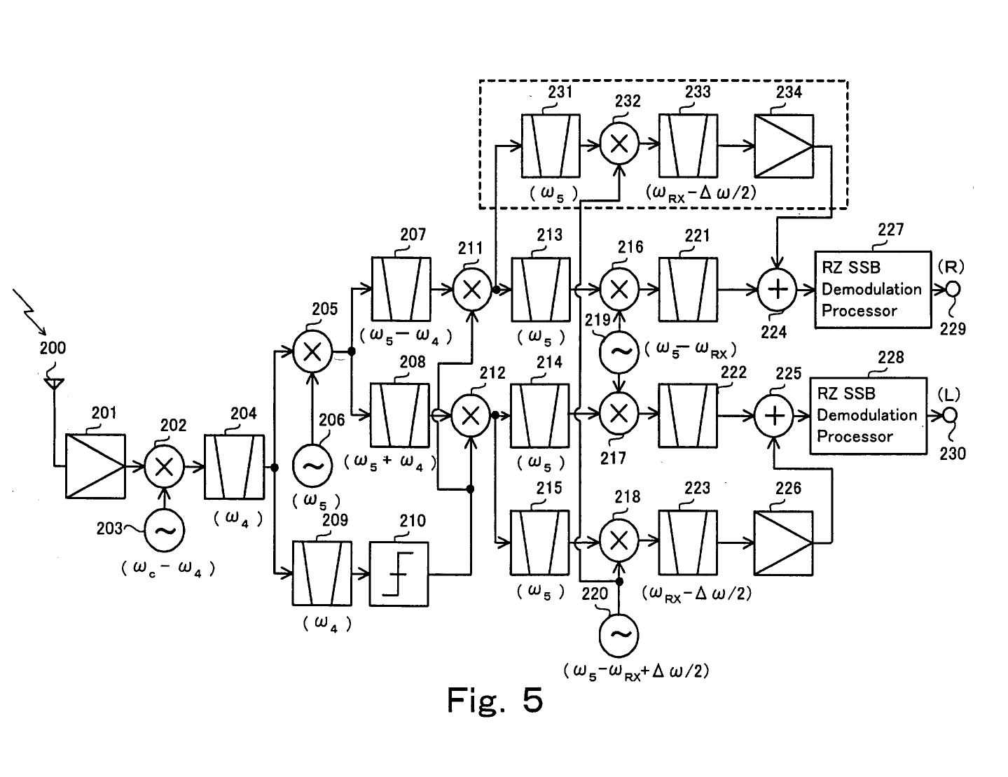

In the embodiment shown in FIG. 3, for the sake of simplicity, the carrier component that was added to the lower sideband—i.e., to the output signals of IF filters 221 and 222—was one that had been extracted from the output of frequency converter 212. However, because the output signals of IF filters 221 and 222 have mutually reversed frequency component distributions in the frequency domain, the carrier component extracted by IF filter 223 is not added in-phase to the output of IF filter 221, with the result that noise components are not cancelled in the RZ SSB processing. If the circuit surrounded by the broken line shown in FIG. 5 is added, the carrier component extracted by IF filter 233 is added in-phase to the output of IF filter 221, so that the noise components are also added in-phase and can be cancelled in the subsequent RZ SSB processing. A brief description will therefore be given of the portion added to the constitution illustrated in FIG. 3. Namely, the added portion in FIG. 5 comprises IF filters 231 and 233, frequency converter 232, and amplifier 234. The operation of this added portion will next be described. The carrier component is extracted from the output signal of frequency converter 211 by IF filter 231 and frequency converted by frequency converter 232, using the signal from local oscillator 220. After the required component has been extracted by IF filter 233, its power level is amplified by amplifier 234. In the embodiment illustrated in FIG. 3, the output of amplifier 226 was added by means of adder 224 to the output of IF filter 221, whereas with the configuration shown in FIG. 5, it is the output of amplifier 234 that is added by adder 224 to the output of IF filter 221.

The foregoing embodiment described a receiving circuit used to receive a stereophonic signal. However, as a modification of this receiving circuit, if the transmitter is a dedicated monophonic transmitter that uses only left-channel audio signal 101 shown in FIG. 1, a possibility that was alluded to in the description of the first embodiment, a dedicated monophonic receiver is sufficient, and hence IF filters 207, 213 and 221, frequency converters 211 and 216, adder 224 and RZ SSB demodulation processor 227, etc., are no longer required and can be removed. Alternatively, if right-channel audio signal 100 is used by a dedicated monophonic transmitter, a dedicated monophonic receiver is sufficient, and hence IF filters 208, 214 and 222, frequency converters 212 and 217, adder 225 and RZ SSB demodulation processor 228, etc., are no longer required and can be removed.

Third Embodiment

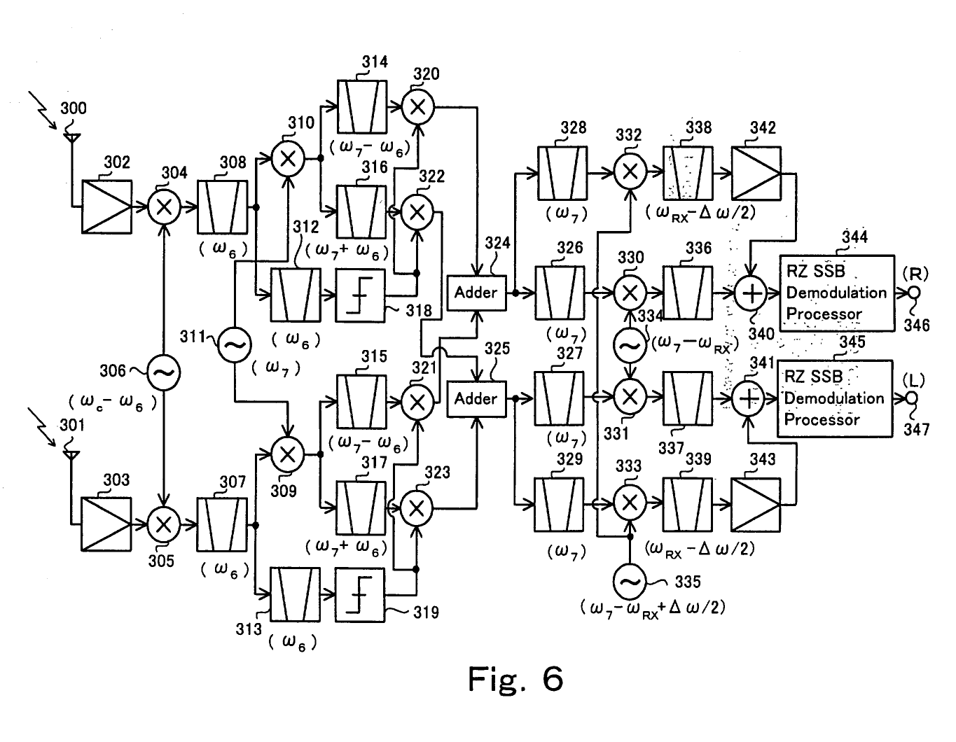

A third embodiment of this invention will now be described with reference to FIG. 6, which is a block diagram of a two-branch space diversity receiving circuit. This receiving circuit is a receiving circuit for receiving the signal that has been transmitted by the transmitting circuit shown in FIG. 1, and comprises: receiving antennas 300 and 301, front end amplifiers 302 and 303, frequency converters 304 and 305, local oscillator 306, IF-filters 307 and 308, frequency converters 309 and 310, local oscillator 311, IF filters 312, 313, 314, 315, 316 and 317, amplitude limiters 318 and 319, frequency converters 320, 321, 322 and 223, adders 324 and 325, IF filters 326, 327, 328 and 329, frequency converters 330, 331, 332 and 333, local oscillators 334 and 335, IF filters 336, 337, 338 and 339, adders 340 and 341, amplifiers 342 and 343, RZ SSB demodulation processors 344 and 345, and demodulated signal output terminals 346 and 347.

The signal flow in the receiving circuit of this third embodiment shown in FIG. 6 and the functioning of its component circuits will now be described.

Because two-branch space diversity receiving is employed, there are two receiving antennas. A description will firstly be given of one branch of this receiving circuit. The signal received by receiving antenna 300 is amplified to the required level by front-end amplifier 302. The amplified signal is then frequency converted by frequency converter 304 using the output signal of local oscillator 306. IF filter 308 extracts the required frequency-converted component without inclusion of unwanted components and without exclusion of the required component. The output signal of IF filter 308 is split into two, and one of the two split signals is converted to difference and sum frequencies by frequency converter 310, using the output signal of local oscillator 311. These difference and sum frequencies are then extracted by IF filters 314 and 316 respectively without inclusion of unwanted components and without exclusion of the required components. IF filter 312 extracts only the carrier component (pilot signal) from the other split output signal of IF filter 308, and amplitude limiter 318 gives this extracted carrier component a constant amplitude. The outputs of IF filters 314 and 316 are respectively input to frequency converters 320 and 322, where they are frequency converted using the output of amplitude limiter 318.

Next, a description will be given of the other branch. The signal received by receiving antenna 301 is amplified to the required level by front-end amplifier 303. The amplified signal is frequency converted by frequency converter 305 using the output signal of local oscillator 306. IF filter 307 extracts the required frequency-converted component without inclusion of unwanted components and without exclusion of the required component. The output signal of IF filter 307 is split into two, and one of the two split signals is converted to difference and sum frequencies by frequency converter 309, using the output signal of local oscillator 311. These difference and sum frequencies are then extracted by IF filters 315 and 317 respectively, without inclusion of unwanted components and without exclusion of the required components. IF filter 313 extracts only the carrier component (pilot signal) from the other split output signal of IF filter 307, and amplitude limiter 319 gives this extracted carrier component a constant amplitude. The outputs of IF filters 315 and 317 are respectively input to frequency converters 321 and 323, where they are frequency converted using the output of amplitude limiter 319.

In this third embodiment, which adopts equal-gain combining as the diversity combining technique, the gain from front-end amplifier 302 to frequency converters 320 and 322, and the gain from front-end amplifier 303 to frequency converters 321 and 323, are set so that they are equal. The outputs of frequency converters 320 and 321 are added in-phase by adder 324, and the outputs of frequency converters 322 and 323 are added in-phase by adder 325. The outputs of these adders are supplied respectively to IF filters 326 and 327, which extract the required component without inclusion of unwanted components and without exclusion of the required component.

In this third embodiment as well, in order to make effective use of the frequency region in which a DSP processor can be utilized, the outputs of IF filters 326 and 327 are shifted to an even lower frequency region. Accordingly, the signals extracted by IF filters 326 and 327 are frequency converted by frequency converters 330 and 331 respectively, using the output signal of local oscillator 334. IF filters 336 and 337 extract only the lower sideband components from the respective frequency-converted signals. Meanwhile, IF filter 328 extracts the carrier component from the output of adder 324, and the extracted carrier component is frequency converted by frequency converter 332 using the output signal of local oscillator 335, whereupon IF filter 338 extracts only the required component from the output of frequency converter 332.

In this embodiment, the frequency of local oscillator 335 is set so that the frequency of the frequency of the frequency-converted signal output from frequency converter 332 matches the carrier frequency component of the lower sideband signal that was previously extracted by IF filters 336 and 337. The output of IF filter 338 is amplified by amplifier 342. The output of amplifier 342 is added by adder 340 to the output of IF filter 336, thereby forming a lower sideband signal with added carrier, whereupon RZ SSB demodulation processing is performed by RZ SSB demodulating processor 344 and a demodulated signal is obtained at demodulated signal output terminal 346.

Similarly, IF filter 329 extracts the carrier component from the output of adder 325, and the extracted carrier component is frequency converted by frequency converter 333 using the output signal of local oscillator 335, whereupon IF filter 339 extracts only the required component from the output of frequency converter 333. The output of IF filter 339 is amplified by amplifier 343. The output of amplifier 343 is added by adder 341 to the output of IF filter 337, thereby forming a lower sideband signal with added carrier, whereupon RZ SSB demodulation processing is performed by RZ SSB demodulation processor 345 and a demodulated signal is obtained at demodulated signal output terminal 347.

The operation of each component circuit will now be described using mathematical expressions. The transmitted wave that has propagated through the propagation path is received by receiving antenna 300 and is then amplified to the required level by front end amplifier 302. Due to multiplicative disturbance occurring in the propagation path, this signal becomes:

SR1(t)=ρ1(t)[K cos((ω_{C}±δω_{c})t'θ1(t))+G_{R}(t)cos((ω_{C}±δω_{c}+Δω/2)t+θ1(t))−H(G_{R}(t))sin((ω_{C}±δω_{c}+Δω/2)t+θ1(t))+G_{L}(t)cos((ω_{C}±δω_{c}−Δω/2)t+θ1(t))+H(G_{L}(t))sin((ω_{C}±δω_{c}−Δω/2)t+θ1(t))] (21)

where ±δω_{c} is the angular frequency fluctuation of the transmitter and ρ1(t) and θ1(t) are respectively the random amplitude fluctuation and the phase fluctuation (random FM noise), which obey the Rayleigh distribution rule and are affected by the propagation path. Hence Equation 21 describes the signal received by receiving antenna 300. This description of the received signal ignores amplifier gain and thermal noise, the latter being additive noise generated in the amplifier.

When the signal described by Equation 21 is frequency converted by frequency converter 304 using the output signal from local oscillator 306, which has a center angular frequency of ω_{C}−ω₆ and an angular frequency fluctuation of ±δω, it becomes:

SR1(t)=ρ1(t)[K cos((Ω₆t+θ1(t))+G_{R}(t)cos((Ω₆+Δω/2)t+θ1(t))−H(G_{R}(t))sin((Ω₆+Δω/2)t+θ1(t))+G_{L}(t)cos((Ω₆−Δω/2)t+θ1(t))+H(G_{L}(t))sin((Ω₆−Δω/2)t+θ1(t))] (22)

and hence only the desired wave is extracted by IF filter 308. To simplify this equation we have used the substitution:

Ω₆=ω₆±δω_{c}±(−δω)

When the output signal from IF filter 308, which can be described by Equation 22, is frequency converted by frequency converter 310 using the output signal from local oscillator 311, which has an angular frequency of ω₇, the difference frequency can be extracted by IF filter 314 and the sum frequency by IF filter 316. The difference frequency component can be described by the following mathematical expression:

SR1sub(t)=ρ1(t)[K cos((ω₇−Ω₆)t−θ1(t))+G_{R}(t)cos((ω₇−Ω₆−Δω/2)t−θ1(t))+H(G_{R}(t))sin((ω₇−Ω₆−Δω/2)t−θ1(t))+G_{L}(t)cos((ω₇−Ω₆+Δω/2)t−θ1(t))−H(G_{L}(t))sin((ω₃−Ω₆+Δω/2)t−θ1(t))] (23)

Because it has been assumed here that ω₇>ω₆, comparison of Equation 22 and Equation 23 shows that the upper and lower sideband components in Equation 22 are transposed in Equation 23. Next, the sum frequency component can be described by the following mathematical expression:

SR1sum(t)=ρ1(t)[K cos((Ω₆+ω₇)t+θ1(t))+G_{R}(t)cos((Ω₆+ω₇+Δω/2)t+θ1(t))−H(G_{R}(t))sin((Ω₆+ω₇+Δω/2)t+θ1(t))+G_{L}(t)cos((Ω₆+ω₇−Δω/2)t+θ1(t))+H(G_{L}(t))sin((Ω₆+ω₇−Δω/2)t+θ1(t))] (24)

and therefore in this case the upper and lower sideband components do not change.

When the carrier component alone is extracted from the output of IF filter 308 by IF filter 312 and its amplitude fixed by amplitude limiter 318, the signal obtained is:

SR1lim(t)=cos(Ω₆t+θ1(t)) (25)

When the output of IF filter 314, which can be described by Equation 23, and the output of amplitude limiter 318, which can be described by Equation 25, are input to frequency converter 320, and the sum frequency generating function of this frequency converter is used, the signal obtained is:

SF1sub(t)=ρ1(t)[K cos(ω₇t)+G_{R}(t)cos((ω₇−Δω/2)t)+H(G_{R}(t))sin((ω₇−Δω/2)t)+G_{L}(t)cos((ω₇+Δω/2)t)−H(G_{L}(t))sin((ω₇+Δω/2)t)] (26)

When the output of IF filter 316, which can be described by Equation 24, and the output of amplitude limiter 318, which can be described by Equation 25, are input to frequency converter 322, and the difference frequency generating function of this frequency converter is used, the signal obtained is:

SF1sum(t)=ρ1(t)[K cos(ω₇t)+G_{R}(t)cos((ω₇+Δω/2)t)−H(G_{R}(t))sin((ω₇+Δω/2)t)+G_{L}(t)cos((ω₇31 Δω/2)t)+H(G_{L}(t))sin((ω₇−Δω/2)t)] (27)

It will be seen that the angular frequency of the carrier component in both Equation 26 and Equation 27 has become ω₇ and that in both equations the angular frequency fluctuation (±δω_{c}±(−δω)) and the random FM noise component θ1(t) have both been completely removed. Moreover, the fact that the angular frequency of the carrier component in both Equation 26 and Equation 27 is ω₇ means that after this stage in the processing, the frequency stability is determined solely by the frequency stability of local oscillator 311.

The transmitted wave that has propagated through the propagation path is also received by receiving antenna 301 and is then amplified to the required level by front end amplifier 303. Due to multiplicative disturbance occurring in the propagation path, this signal becomes:

SR2(t)=ρ2(t)[K cos((ω_{C}±δω_{c})t+θ2(t))+G_{R}(t)cos((ω_{C}±δω_{c}+Δω/2)t+θ2(t))−H(G_{R}(t))sin((ω_{C}±δω_{c}+Δω/2)t+θ2(t))+G_{L}(t)cos((ω_{C}±δω_{c}−Δ107 /2)t+θ₂(t))+H(G_{L}(t))sin((ω_{C}±δω_{c}−Δω/2)t+θ2(t))] (28)

where ±δω_{c} is the angular frequency fluctuation of the transmitter and ρ2(t) and θ2(t) are respectively the random amplitude fluctuation and the phase fluctuation (random FM noise), which obey the Rayleigh distribution rule and are affected by the propagation path. Hence Equation 28 describes the signal received by receiving antenna 301. This description of the received signal ignores amplifier gain and thermal noise, the latter being additive noise generated in the amplifier.

When the signal described by Equation 28 is frequency converted by frequency converter 305 using the output signal from local oscillator 306, which has a center angular frequency of ω_{C}−ω₆ and an angular frequency fluctuation of ±δω, it becomes:

SR2(t)=ρ2(t)[K cos((Ω₆t+θ2(t))+G_{R}(t)cos((Ω₆+Δω/2)t+θ2(t))−H(G_{R}(t))sin((Ω₆+Δω/2)t+θ2(t))+G_{L}(t)cos((Ω₆−Δω/2)t+θ2(t))+H(G_{L}(t))sin((Ω₆−Δω/2)t+θ2(t))] (29)

and hence only the desired wave is extracted by IF filter 307.

For the sake of simplicity, the IF frequency conversions described by Equation 22 and Equation 29 were described as being implemented by IF frequency converters having just one stage, but in practice the number of stages can easily be increased as required.

When the output signal from IF filter 307, which can be described by Equation 29, is frequency converted by frequency converter 309 using the output signal from local oscillator 311, which has an angular frequency of ω₇, the difference frequency can be extracted by IF filter 315 and the sum frequency by IF filter 317. The difference frequency component can be described by the following mathematical expression:

SR2sub(t)=ρ2(t)[K cos((ω₇−Ω₆)t−θ2(t))+G_{R}(t)cos((ω₇−Ω₆−Δω/2)t−θ2(t))+H(G_{R}(t))sin((ω₇−Ω₆−Δω/2)t−θ2(t))+G_{L}(t)cos((ω₇−Ω₆+Δω/2)t−θ2(t))−H(G_{L}(t))sin((ω₇−Ω₆+Δω/2)t−θ2(t))] (30)

Because it has been assumed here that ω₇>ω₆, comparison of Equation 29 and Equation 30 shows that the upper and lower sideband components in Equation 29 are transposed in Equation 30. Next, the sum frequency component can be described by the following mathematical expression:

SR2sum(t)=ρ2(t)[K cos((Ω₆+ω₇)t+θ2(t))+G_{R}(t)cos((Ω₆+ω₇+Δω/2)t+θ2(t))−H(G_{R}(t))sin((Ω₆+ω₇+Δω/2)t+θ2(t))+G_{L}(t)cos((Ω₆+ω₇−Δω/2)t+θ2(t))+H(G_{L}(t))sin((Ω₆+ω₇−Δω/2)t+θ2(t))] (31)

and therefore in this case the upper and lower sideband components do not change.

When the carrier component alone is extracted from the output of IF filter 307 by IF filter 313 and its amplitude fixed by amplitude limiter 319, the signal obtained is:

SR2lim(t)=cos(Ω₆t+θ2(t)) (32)

When the output of IF filter 315, which can be described by Equation 30, and the output of amplitude limiter 319, which can be described by Equation 32, are input to frequency converter 321, and the sum frequency generating function of this frequency converter is used, the signal obtained is:

SF2sub(t)=ρ2(t)[K cos(ω₇t)+G_{R}(t)cos((ω₇−Δω/2)t)+H(G_{R}(t))sin((ω₇−Δω/2)t)+G_{L}(t)cos((ω₇+Δω/2)t)−H(G_{L}(t))sin((ω₇+Δω/2)t)] (33)

When the output of IF filter 317, which can be described by Equation 31, and the output of amplitude limiter 319, which can be described by Equation 32, are input to frequency converter 323, and the difference frequency generating function of this frequency converter is used, the signal obtained is:

SF2sum(t)=ρ2(t)[K cos(ω₇t)+G_{R}(t)cos((ω₇+Δω/2)t)−H(G_{R}(t))sin((ω₇+Δω/2)t)+G_{L}(t)cos((ω₇−Δω/2)t)+H(G_{L}(t))sin((ω₇−Δω/2)t)] (34)

It will be seen that the angular frequency of the carrier component in both Equation 33 and Equation 34 has become ω₇ and that in both equations the angular frequency fluctuation (±δω_{c}±(−δω)) and the random FM noise component θ2(t) have both been completely removed. Moreover, the fact that the angular frequency of the carrier component in both Equation 33 and Equation 34 is ω₇ means that after this stage in the processing, the frequency stability is determined solely by the frequency stability of local oscillator 311.

Next, the outputs of frequency converters 320 and 321, i.e., the signals expressed by Equation 26 and Equation 33, are added in-phase by adder 324 to give:

SFtsub(t)=(ρ1(t)+ρ2(t))[K cos(ω₇t)+G_{R}(t)cos((ω₇−/2)t)+H(G_{R}(t))sin((ω₇−Δω/2)t)+G_{L}(t)cos((ω₇+Δω/2)t)−H(G_{L}(t))sin((ω₇+Δω/2)t)] (35)

and the outputs of frequency converters 322 and 323, i.e., the signals expressed by Equation 27 and Equation 34, are added in-phase by adder 325 to give:

SFtsum(t)=(ρ1(t)+ρ2(t))[K cos(ω₇t)+G_{R}(t)cos((ω₇+Δω/2)t)−H(G_{R}(t))sin((ω₇+Δω/2)t)+G_{L}(t)cos((ω₇−Δω/2)t)+H(G_{L}(t))sin((ω₇−Δω/2)t)] (36)

The signals described by Equation 35 and Equation 36 are extracted by IF filters 326 and 327 respectively. RZ SSB demodulation processing can then be performed on the basis of these signals. However, because the frequency region in which a DSP processor can be effectively used is limited, it was decided in the present invention that the signals described by Equation 35 and Equation 36 would be shifted to as low a frequency region as possible.

Accordingly, when the respective outputs of IF filters 326 and 327 are shifted to a low frequency region by frequency converters 330 and 331 using the output of local oscillator 334 having angular frequency ω₇−ω_{RX}, and the lower sideband component alone is extracted using IF filters 336 and 337, the output signal from IF filter 336 is given by:

SZtsub(t)=(ρ1(t)+ρ2(t))[G_{R}(t)cos((ω_{RX}−Δω/2)t)+H(G_{R}(t))sin((ω_{RX}−Δω/2)t)] (37)

and the output signal from IF filter 337 is given by:

SZtsum(t)=(ρ1(t)+ρ2(t))[G_{L}(t)cos((ω_{RX}31 Δω/2)t)+H(G_{L}(t))sin((ω_{RX}−Δω/2)t)] (38)

Meanwhile, the carrier component is extracted by IF filters 328 and 329 from the output signals of adders 324 and 325, and frequency converted by frequency converters 332 and 333 using the output of local oscillator 335 having angular frequency ω₇−ω_{RX}+Δω/2. The effective component is then extracted by IF filters 338 and 339. The output signal of IF filter 338 is:

SRZScari(t)=(ρ1(t)+ρ2(t))cos((ω_{RX}−Δω/2)t) (39)

and the output signal of IF filter 339 is:

SRZWcari(t)=(ρ1(t)+ρ2(t))cos((ω_{RX}−Δω/2)t) (40)

If we look only at the carrier component, the two signals represented by Equation 39 and Equation 40 are the same, but their noise components in the vicinity of the carrier have mutually reversed frequency component distributions, and therefore the outputs of filters 338 and 339 are used for the outputs of filters 336 and 337 respectively.

When the power of the output signal from IF filter 338 is amplified by amplifier 342 and added by means of adder 340 to the output of IF filter 336, the output of IF filter 336 is converted to a lower sideband signal to which has been added a carrier component with the same frequency relation to the frequency-converted sideband as that between the carrier used to form the sideband transmitted by the transmitting means and the transmitted sideband. The output signal of adder 340 is given by:

SRZtsub(t)=(ρ1(t)+ρ2(t))[(1+G_{R}(t))cos((ω_{RX}−Δω/2)t)+H(G_{R}(t))sin((ω_{RX}−Δω/2)t)] (41)

This signal is demodulated by RZ SSB demodulation processor 344, whereupon a demodulated signal is obtained at demodulated signal output terminal 346.

Similarly, the power of the output signal from IF filter 339 is amplified by amplifier 343 and added by means of adder 341 to the output of IF filter 337, whereby it is converted to a lower sideband signal. The output signal of adder 341 is given by:

SRZtsum(t)=(ρ1(t)+ρ2(t))[(1+G_{L}(t))cos((ω_{RX}−Δω/2)t)+H(G_{L}(t))sin((ω_{RX}−Δω/2)t)] (42)

This signal is demodulated by RZ SSB demodulation processor 345, whereupon a demodulated signal is obtained at demodulated signal output terminal 347.

A necessary condition for the RZ SSB demodulation processing to function is that:

|G_{R}(t)|<1

|G_{L}(t)|<1

and hence the degree of amplification provided by amplifiers 342 and 343 is set so that this condition is satisfied.

The embodiment shown in FIG. 6 is a two-branch space diversity receiving circuit used to receive a stereophonic signal. However, if the transmitting circuit is a dedicated monophonic transmitter that transmits only left-channel audio signal 101 shown in FIG. 1, a dedicated monophonic receiving circuit is sufficient, and hence IF filters 314, 315, 326, 328, 336 and 338, frequency converters 320, 321, 330 and 332, adders 324 and 340, amplifier 342, RZ SSB demodulation processor 344, etc., are no longer required and can be removed. Alternatively, if right-channel audio signal 100 only is used by a dedicated monophonic transmitting circuit, a dedicated monophonic receiving circuit is sufficient, and hence IF filters 316, 317, 327, 329, 337 and 339, frequency converters 322, 323, 331 and 333, adders 325 and 341, amplifier 343, RZ SSB demodulation processor 345, etc., are no longer required and can be removed.

The foregoing embodiments were described using the example of radio microphone equipment, but the present invention is not restricted to this and can be embodied in a variety of applications. For example, the invention can be utilized for bidirectional communication between a plurality of transceivers, each transceiver incorporating a transmitting circuit and a receiving circuit in the same casing. Alternatively, the invention can be embodied in a configuration where transceivers communicate via a radio base station, as in the case of mobile telephony.

As has been described above, the present invention provides the following benefits:

1. Because it uses single-sideband modulation technology, the required transmission bandwidth is equal to the bandwidth of the information signal, thereby achieving significantly greater bandwidth narrowing than can be achieved with conventional modulation techniques.

2. Because the receiving circuit of the invention is constituted in such manner that a high-quality demodulated signal is obtained provided that frequency fluctuation is within the signal processing range, the quality of the demodulated signal does not deteriorate due to frequency instability.

3. Receiving characteristics are resistant to multiplicative noise associated with disturbance such as fading, and hence a high-quality demodulated signal is obtained.

What is claimed is:

1. A radio communication system comprising:
transmitting means for allocating an information signal to a suppressed carrier sideband of a single-sideband signal, and for transmitting, said sideband along with a pilot signal, said pilot signal being a carrier component with a different frequency from the carrier used to form said sideband; and
receiving and demodulating means for receiving and demodulating the signal transmitted from said transmitting means;
wherein said receiving and demodulating means comprises:
means for forming a single-sideband signal, said means performing separate frequency conversions of the sideband and the pilot signal in the received signal, thereby providing a carrier component with the same frequency relation to the frequency-converted sideband as that between the carrier used to form the sideband transmitted by said transmitting means and said transmitted sideband; and
means for demodulating the information signal from the phase term of the single-sideband signal thereby obtained.

2. The radio transmission system of claim 1, wherein:
said transmitting means is adapted to transmit after allocating one of two independent information signals to the upper sideband and the other information signal to the lower sideband; and
said receiving and demodulating means is adapted to demodulate the upper sideband and the lower sideband as separate single sidebands.

3. A transmitting circuit comprising:
means for modulating a carrier with an information signal to form a single-sideband suppressed carrier signal; and
means for adding a pilot signal to this single-sideband suppressed carrier signal, this pilot signal being a carrier component with a different frequency from said carrier.

4. The transmitting circuit of claim 3, wherein:
said means for forming a single-sideband suppressed carrier signal comprises first circuit means for using one of two independent information signals and a signal of first angular frequency ω₁ to form a suppressed carrier upper sideband signal, and second circuit means for using the other of said two independent information signals and a signal of second angular frequency ω₂ to form a suppressed carrier lower sideband signal; and
said means for adding a pilot signal comprises third circuit means for adding said suppressed carrier upper sideband signal, said suppressed carrier lower sideband signal, and a pilot signal of third angular frequency ω₃ such that ω₁>ω₃>ω₂.

5. The transmitting circuit of claim 4, wherein said third angular frequency ω₃ has been set so that ω₃=(ω₁+ω₂)/2.

6. A receiving circuit for receiving, along with a carrier component, a modulated wave resulting from an information signal having been allocated to a sideband, and for demodulating said modulated wave; wherein
said carrier component is a pilot signal with a different frequency from the carrier used to form said sideband; and
said receiving circuit comprises:
means for forming a single-sideband signal, said means performing separate frequency conversions of the sideband and the pilot signal in the received signal, thereby providing a carrier component with the same frequency relation to the frequency-converted sideband as that between the carrier used to form the transmitted sideband and said transmitted sideband; and
means for demodulating the information signal from the phase term of the single-sideband signal thereby obtained.

7. The receiving circuit of claim 6, wherein:
the received signal is a signal comprising an upper sideband and a lower sideband that have been modulated by independent information signals; and
said means for forming a single-sideband signal comprises means for separately processing the upper sideband and the lower sideband.

8. The receiving circuit of claim 7, wherein said processing means comprises means for forming, from the received signal, two independent signals occupying the same frequency range but which have mutually reversed frequency component distributions in the frequency domain.

9. The receiving circuit of claim 8, wherein said means for forming two independent signals comprises:
first frequency conversion means for using a first local oscillator signal to frequency convert the received signal to a first frequency band (ω₄);
second frequency conversion means for using a second local oscillator signal (ω₅) of a higher frequency than said first local oscillator signal to frequency convert the output of said first frequency conversion means, and for extracting the difference frequency component (ω₅−ω₄) and the sum frequency component (ω₅+ω₄), which have mutually reversed frequency component distributions in the frequency domain;
pilot signal extraction means for branching the output of said first frequency conversion means, limiting the amplitude, and extracting the pilot signal (ω₄);
third frequency conversion means for using the extracted pilot signal to frequency convert said difference frequency component, and for extracting the sum frequency component (ω₅); and
fourth frequency conversion means for using said extracted pilot signal to frequency convert the sum frequency component that has been extracted by said second frequency conversion means, and for extracting the difference frequency component (ω₅).

10. The receiving circuit of claim 8, wherein:
a plurality of receiving antennas is provided;
each of this plurality of receiving antennas is provided with means for forming said two independent signals; and
means is provided for adding the corresponding independent signals that are output from each of said means for forming the two independent signals.

11. The receiving circuit of claim 8, wherein said processing means comprises:
means for using a third local oscillator signal to frequency convert each of said two independent signals;
means for branching at least one of said two independent signals; using a fourth local oscillator signal differing from said third local oscillator signal by a prescribed frequency to frequency convert the branched signal; and extracting a carrier component with the same frequency relation to the sidebands of said two independent signals as that between the carrier used to form the sidebands transmitted by said transmitting means and said transmitted sidebands; and
means for adding this extracted carrier component to the output of said means for using the third local oscillator signal to frequency convert each of said two independent signals.

12. The receiving circuit of claim 11, wherein:
said means for extracting the carrier component is adapted to use the same local oscillator signal to separately extract, for each of said two independent signals, the carrier component; and
said adding means is adapted to add, for each of said two independent signals, the output of said frequency conversion means and the output of said extraction means.
